(19) United States
(12) Patent Application Publication
(10) Pub. No.: US 2004/0104662 A1
(43) Pub. Date: Jun. 3, 2004

(54) Electron gun, cathode ray tube, and image display apparatus

(76) Inventors: Hirofumi Nakamura, Aichi (JP); Hideki Miyazaki, Aichi (JP); Masatoki Morimoto, Aichi (JP); Kouji Shibusa, Aichi (JP); Toshinori Suzuki, Aichi (JP)

Correspondence Address: Ronald P Kananen, Rader Fishman & Grauer, Suite 501, 1233 20th Street N W, Washington, DC, 20036, US

(21) Appl. No.: 10/470,243

(22) PCT Filed: Jan. 24, 2002
(86) PCT No.: PCT/JP02/00502

(30) Foreign Application Priority Data
Jan. 26, 2001 (JP) 2001-19054
Aug. 15, 2001 (JP) 2001-246678

(51) Int. Cl. H01J 29/46; H01J 1/02

(52) U.S. Cl. 313/446; 313/309

(57) ABSTRACT

The present invention achieves a screen of high luminance with an excellent focus characteristic.

The tip of a cathode is formed, for example, in a plane shape or a curved surface shape. The tip formed in the plane shape or curved surface shape is used as an electron emission face and is allowed to either enter a hole in a first grid or enter the hole to project from the first grid. An electron beam emitted from the electron emission face can be made almost a parallel beam. Even when the beam current amount is increased, an almost parallel beam can be obtained. Thus, a screen of high luminance can be obtained with an excellent focus characteristic.

### TECHNICAL FIELD

The present invention relates to an electron gun, a cathode ray tube, and an image display device. More specifically, the invention realizes image display of high luminance with an excellent focus characteristic by forming a tip of cathode in a plane shape or in a convex-shaped curved surface, using the tip or the convex-shaped curved surface as electron emission face and making the tip or the convex-shaped curved surface enter a hole in a first grid to project from said first grid.

### BACKGROUND ART

Hitherto, in an electron gun of a cathode ray tube, by controlling a bias voltage between a first grid and a cathode, an amount of an electron beam emitted from the cathode is adjusted and the brightness of a screen is accordingly controlled. To improve the focus characteristic of the electron gun so as to realize high-resolution display, the diameter of a hole opened in the first grid facing the cathode is reduced to, at present, about a hole diameter corresponding to 0.3 mm.

When the hole diameter is reduced, it becomes very difficult to process the portion around the hole by a die. The relative positioning between a first grid and a second grid has to be adjusted with high precision by using an assembly jig. Thus, an electron gun cannot be assembled efficiently.

When the hole diameter is reduced, the amount of electrons taken out as an electron beam from electrons emitted from the cathode becomes smaller, and luminance of the screen decreases. Consequently, to obtain a high-luminance screen even when the hole diameter is reduced, the amount of electrons emitted from the cathode has to be increased by making a drive voltage higher. However, if the drive voltage becomes high, at the time of drive at a high frequency for high-resolution display, an operation following the drive signal cannot be performed and it causes deterioration in the frequency characteristic.

An object of the present invention is, therefore, to provide an electron gun, a cathode ray tube, and an image display device, which are capable of obtaining a high-luminance screen with an excellent focus characteristic.

### DISCLOSURE OF INVENTION

An electron gun according to the invention comprises a cathode having a tip thereof, the tip being formed in a plane shape or in a convex-shaped curved surface, and the plane tip or the convex-shaped curved surface is used as electron emission face and enters a hole in a first grid to project from the first grid.

A cathode ray tube comprises an electron gun including a cathode having a tip thereof, the tip being formed in a plane shape or in a convex-shaped curved surface so that the tip or the convex-shaped curved surface is used electron emission face and enters a hole in a first grid to project from the first grid.

Further, an image display device comprises a cathode ray tube including an electron gun having a cathode with a tip thereof, the tip being formed in a plane shape or in a convex-shaped curved surface, so that the plane tip or the convex-shaped curved surface is used electron emission face and enters a hole in a first grid to project from the first grid, and a drive circuit for driving the cathode ray tube to display an image.

According to the invention, a tip of a cathode is formed in a plane shape or a curved surface shape. The tip formed in the plane shape or curved surface shape is used as an electron emission face and enters the hole to project from the first grid. With the configuration, an electron beam emitted from the electron emission face is made almost a parallel beam.

### BRIEF DESCRIPTION OF THE DRAWINGS

FIG. 1 is a diagram showing a schematic configuration of an image display device.

FIG. 2 is a diagram showing a schematic configuration of a cathode ray tube.

FIG. 3 is a diagram showing a schematic configuration of an electron gun.

FIG. 4 is sectional schematic diagrams each illustrating a cathode and a first grid.

FIGS. 5A to 5C are diagrams each showing the locus of electron beam

FIG. 6 is a diagram showing the relation between drive voltage and cathode current.

FIGS. 7A to 7C are diagrams showing other surface shapes of a cathode base.

FIGS. 8A and 8B are diagrams each showing the locus of electron beam when the tip of the cathode is formed as a projected face.

FIGS. 9A and 9B are diagrams each showing the locus of electron beam when the tip of the cathode is formed in a cone shape.

FIG. 10 is a diagram showing the relation between the shape of the tip of the cathode and the first grid.

FIG. 11 is a diagram showing the locus of electron beam when the tip from a position of the first grid is formed in a curved face of a convex shape.

### BEST MODE FOR CARRYING OUT THE INVENTION

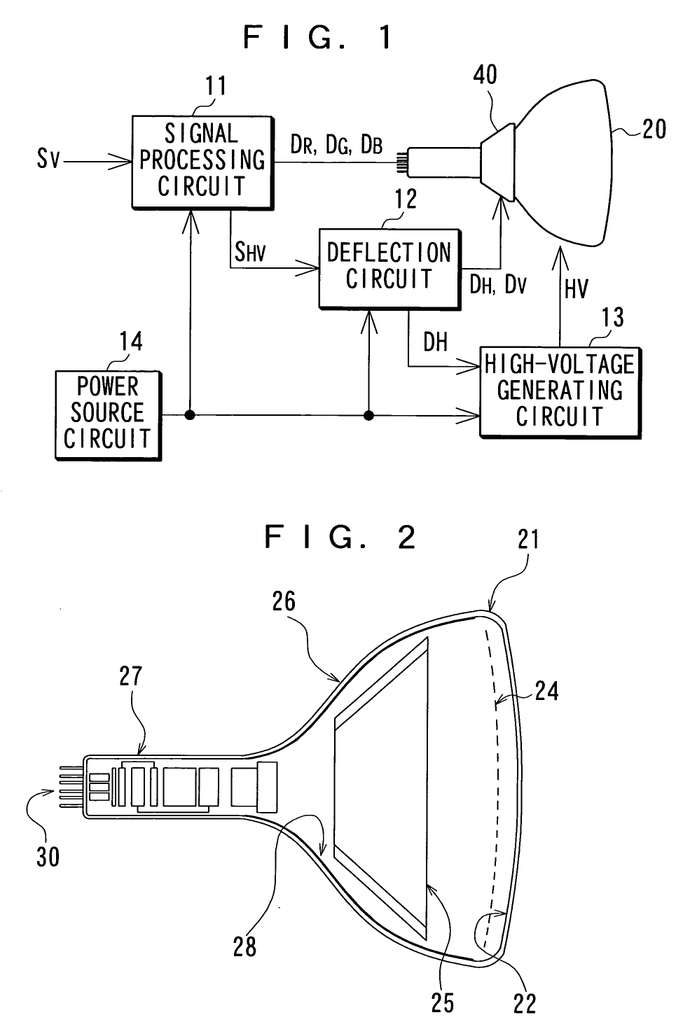

An embodiment of the invention will be described hereinbelow with reference to the drawings. FIG. 1 shows a schematic configuration of an image display device. A signal processing circuit 11 generates three-primary-color signals DR, DG, and DB on the basis of a supplied image signal Sv and supplies the generated signals to a cathode ray tube 20. The signal processing circuit 11 also supplies a sync signal SHV to a deflection circuit 12. The deflection circuit 12 generates a horizontal deflection current DH and a vertical deflection current DV, which are synchronized with the supplied sync signal SHV, and supplies the currents to a deflecting coil 40 attached to the cathode ray tube 20. The deflection circuit 12 also supplies the horizontal deflection current DH to a high-voltage generating circuit 13. The high-voltage generating circuit 13 increases a pulse voltage of the horizontal deflection current DH by a flyback transformer and also rectifies the pulse voltage, thereby generating an anode voltage HV or the like necessary for displaying an image in the cathode ray tube, and the anode voltage HV is supplied to the cathode ray tube 20. A power source circuit 14 supplies a power necessary for the signal processing circuit 11, deflection circuit 12, and high-voltage generating circuit 13.

FIG. 2 shows a schematic configuration of the cathode ray tube 20. On the inner face of a panel 21, a phosphor screen 22 made by a three-color phosphor layer which emits red, green, and blue light is formed. On the phosphor screen 22, a metal-backed phosphor screen (not shown) as an aluminum deposition film is formed. To the panel 21 on which the phosphor screen 22 and the metal-backed phosphor screen are formed, an aperture grill or a shadow mask is attached as a color selection mechanism 24. Further, an internal magnetic shield member 25 is attached and a funnel 26 is then welded to the panel 21, thereby forming a bulb. An electron gun 30 is inserted to a neck 27 of the bulb and the stem of the electron gun 30 and the neck 27 are then welded, thereby shielding the electron gun. On the inside of the funnel 26, a conductive film 28 electrically connected to the metal-backed phosphor screen is formed.

FIG. 3 shows a schematic configuration of the electron gun 30. The electron gun 30 has three cathodes 31R, 31G, and 31B which are in-line arranged in parallel. From the cathode 31 toward an anode side, a first grid 32, a second grid 33, a third grid 34, a fourth grid 35, a fifth grid 36, a sixth grid 37, and a shield cup 38 are sequentially coaxially disposed.

The electron gun 30 is, for example, an electron lens consisting of a plurality of main lenses and is conducted when the second and fourth grids 33 and 35 are electrically connected to each other. The fifth grid corresponding to a focus electrode is divided into two grids; a fifth grid 36-1 as a first focus electrode and a fifth grid 36-2 as a second focus electrode positioned on the anode side. Further, the third grid 34 and the fifth grid 36-2 are electrically connected to each other to achieve conduction.

To the first grid 32, for example, a voltage of 0V (or tens +V) is applied. To the second grid 33 and the fourth grid 35, for example, a voltage of 200 to 800V is applied. To the sixth grid 37, for example, the anode voltage HV of 22 kV to 30 kV is applied.

To the third grid 34 and the fifth grid 3&2, for example, a predetermined focus voltage is applied. On the other hand, to the divided fifth grid 36-1, for example, a dynamic focus voltage is applied. By the application, a quadrupole lens (not shown) is formed between the divided fifth grids 36-1 and 36-2. Moreover, the quadruple lens causes an intensity change in a main lens (focus lens, not shown) ML formed between the fifth grid 36-2 and the sixth grid 37, thereby enabling the shape of an electron beam in the screen peripheral portion in the horizontal direction of the phosphor screen 22 to be preferable one.

Thermoelectrons emitted from the cathode 31 are accelerated and focused with them passing through the grids 32 to 37 of the electron gun 30. They then pass through predetermined electron beam pass holes in the color selection mechanism 24 and fall on the phosphor screen 22.

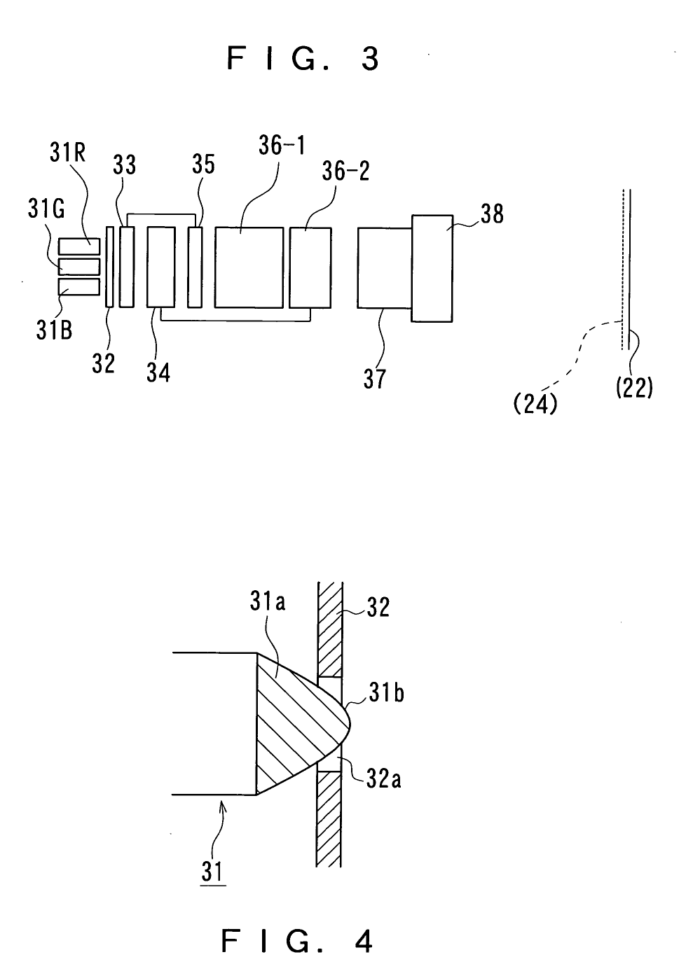

It is assumed that, for example, an impregnated cathode is used as the cathode 31. The cathode 31 is attached in a state where a tip of the cathode 31 enters the hole to project from the first grid 32. FIG. 4 shows sectional schematic diagrams of the cathode and the first grid. At the tip of the cathode 31, for example, a cathode base 31a made of a composite carbonate of alkali earth metals of Ba, Sr, and Ca is provided, and the surface of the cathode base 31a has a convex shape. The cathode 31 is attached so that the top portion 31b of the convex-shaped surface of the cathode base 31a enters a hole 32a formed in the first grid 32 to project to the phosphor screen side. The projection amount from the surface on the second grid side of the first grid 32 to the top portion 31b is set to be equal to or smaller than the average diameter of the hole 32a in the first grid 32 at the maximum, preferably, 0 to 50% of the average diameter of the hole 32a and, more preferably, 0 to 20% of the average diameter of the hole 32a. For example, when the average diameter of the hole 32a is 500 μm, 0 to 100 μm is the most preferable.

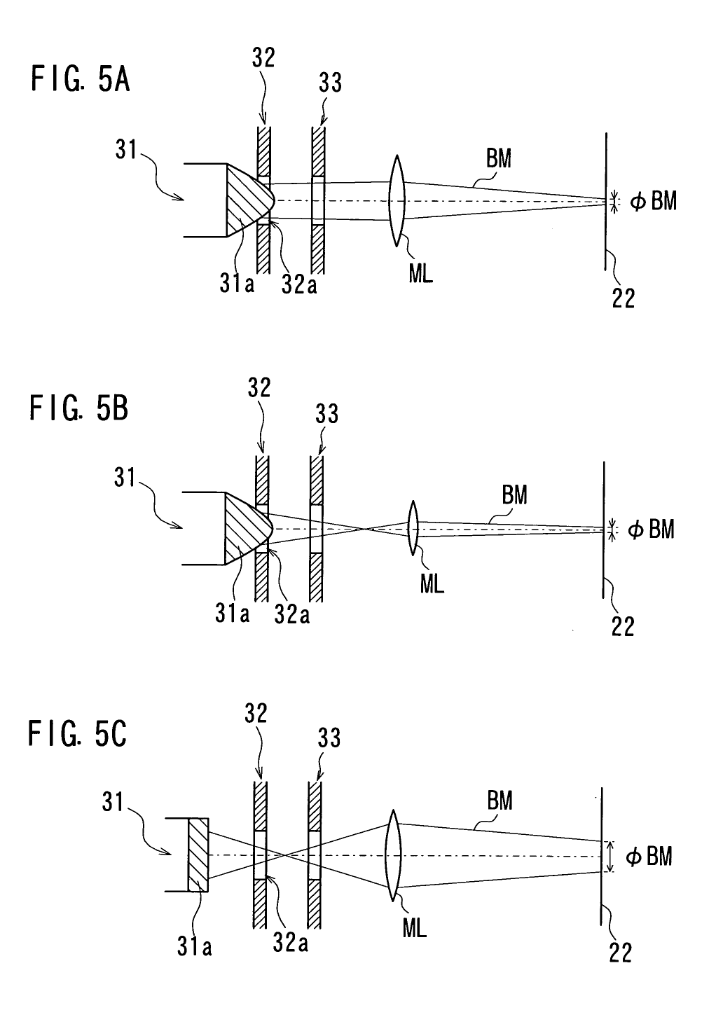

FIGS. 5A to 5C show the loci of electron beams each emitted from the cathode 31. As shown in FIG. 5A, an electron beam BM emitted from the top portion 31b entered the hole 32a in the first grid 32 to project to the phosphor screen side travels toward the second grid 33 and is focused by the main lens ML formed between the fifth grid 36-2 and the sixth grid 37 with the spot diameter φBM of the electron beam BM reducing.

Since the top portion 31b enters the hole 32a in the first grid 32 to project to the phosphor screen side, even when a crossover is form, the crossover is not formed on the cathode side of the second grid 33 as shown in FIG. 5B. Consequently, as compared with the case where a crossover is formed on the cathode side of the second grid 33 as in the conventional electron gun shown in FIG. 5C, the electron beam BM becomes close to a parallel beam. An electric field can be concentrated on the top portion of the cathode base 31a which enters the hole 32a in the first grid 32 to project to the phosphor screen side. Consequently, of the surface of the cathode base 31a, the electron emission face, that is, the working area from which electrons are emitted can be made small. Thus, an emission angle of the electron beam BM is small and the working area is accordingly small, so that the spot diameter φBM of the electron beam BM on the phosphor screen 22 becomes small. Thus, the focus characteristic can be improved.

Since the top portion of the surface of the cathode serves as a working area and the working area is the center portion in which an electric field is concentrated, current density in the center portion becomes high, thereby obtaining a sharp beam spot.

Further, since the top portion 31b of the surface of the cathode base 31a enters the hole 32a to project to the phosphor screen side, the emitted electrons can be efficiently used as an electron beam. This allows perviance to be improved, thereby obtaining a large beam current if using the same cut-off voltage. If using a low drive voltage, a larger beam current as compared with the conventional electron gun can be also obtained. Thus, a display screen of high luminance can be obtained.

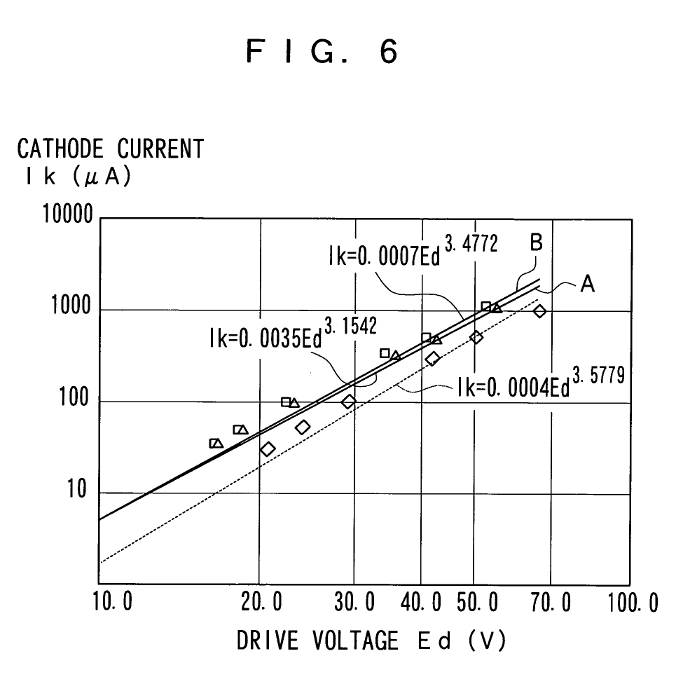

FIG. 6 shows the relation between a drive voltage Ed and a cathode current Ik in the electron gun of the present invention and that in a conventional electron gun. Note that the drive voltage Ed shows a change amount of the cathode voltage when the cut-off voltage at which the emission amount of the electron beams becomes “0” is used as a reference. ⋄ marks show results of measurement in the conventional electron gun, and Δ marks and □ marks denote results of measurement in the electron gun in which the top portion 31b is projected from the hole 32a (the Δ mark has curvature R=0.2 of the surface of the cathode base 31a, and the □ mark has curvature R=0.1).

As shown in this diagram, as compared with the conventional electron gun (whose characteristic is shown by a broken line) from which the measurement result of the ⋄ marks is obtained, the electron gun (whose characteristic is shown by solid line A) from which the measurement result of the Δ marks is obtained and the electron gun (whose characteristic is shown by solid line B) from which the measurement result of the □ marks is obtained can obtain a larger cathode current Ik if using the same drive voltage Ed. In other words, the electric guns can decrease drive voltage Ed if using the same cathode current Ik. This is achieved because the cathode 31 is set closer to the second grid 33, that is, the acceleration electrode in the first stage.

For example, when the cathode current Ik is 300 μA, the conventional drive voltage Ed is 42.2V. On the other hand, in the electron gun of the present invention, the drive voltage Ed can be decreased to 33.2V. When the cathode current Ik is 500 μA, the conventional drive voltage Ed is 50.6V whereas the drive voltage Ed of the present invention is 40.6V. In the case of 1000 μA, the conventional drive voltage Ed is 65.9V whereas the drive voltage Ed of the present invention can be 54.2V. For the same cathode current Ik, the drive voltage Ed can be decreased by about 10V as compared with the conventional drive voltage Ed.

Further, as shown by the solid lines A and B, by reducing the curvature, the larger cathode current Ik can be obtained with the same drive voltage ED or the lower drive voltage Ed can be obtained with the same cathode current Ik.

As described above, the beam amount of an electron beam with respect to the drive voltage can be increased, so that high luminance of the screen can be realized. Since the screen of high luminance can be obtained without increasing the drive voltage, even in the case of performing driving at a high frequency for high-resolution display, an operation which follows the drive signal can be performed. Thus, deterioration in the frequency characteristic can be prevented and a light, clear display image can be obtained.

In the impregnated cathode, to reduce the work function of the cathode surface and facilitate emission of electrons, a thin film made of Ir, Os, Ru, Sc, or the like is formed on the surface of the cathode by sputtering. As the thin film formation area, the area of the top portion 31b which enters the hole 32a to project to the phosphor screen side is used, thereby making the area to be smaller than the hole 32a in the first grid 32. In such a manner, the electron emission area is limited and the focus characteristic can be further improved.

As the type, the cathode 31 is not limited to the impregnated cathode but an oxide cathode may be also employed. By changing the aspect ratio of curvature (the ratio between curvature in the horizontal direction and curvature in the vertical direction) in the surface of the cathode base 31a to a value other than 1, an effect of astigmatism is obtained and it also enables the spot shape of the electron beam to be improved.

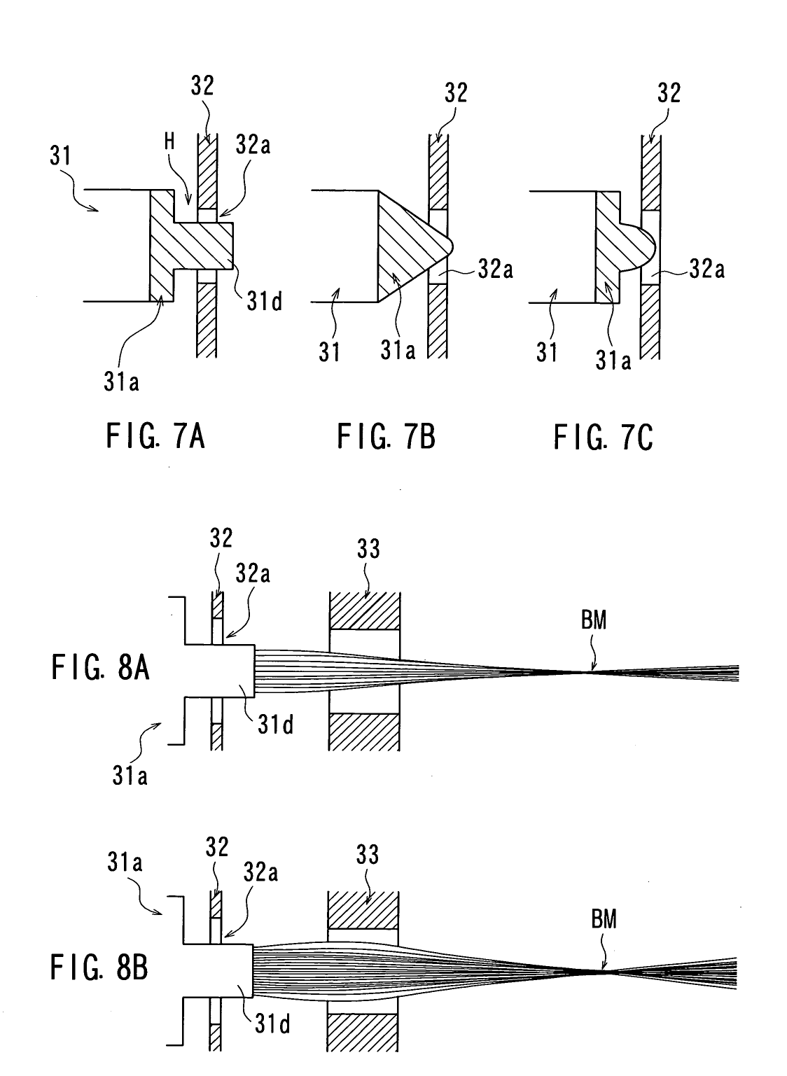

Further, as the surface shape of the cathode base 31a, various shapes can be considered as shown in FIGS. 7A to 7C. For example, a shape as shown in FIG. 7A may be employed in which a step H is provided between a center portion 31d of the cathode base 31a and the other portion, the center portion 31d is formed to be smaller than the hole 32a in the first grid 32 so that the tip of the center portion 31d in the plane enters the hole 32a in the first grid 32 to project to the phosphor screen side. As shown in FIG. 7B, the surface of the cathode may also have a cone shape (the tip has a curved face). Further, a shape as shown in FIG. 7C may be also employed such that a portion which enters the hole 32a in the first grid 32 to project to the phosphor screen side is formed in a dome shape and the other portion is recessed from the first grid 32. By forming the cathode base 31a in any of the shapes as shown in FIGS. 7A to 7C, actions and effects similar to that of the case of FIG. 4 can be obtained.

FIGS. 8A and 8B show the loci of electron beams in the case of using the cathode base shown in FIG. 7A. FIG. 8A shows a case where the amount of the beam current is small (for example, in the cathode ray tube of a television, current from one cathode base is about 0 to 1.5 mA). FIG. 8B shows a case where the current amount is large (for example, in the cathode ray tube of a television, a peak current from one cathode base is about 3 mA). As described above, by forming the cathode base so that the center portion 31d having the plane tip enters the hole 32a in the first grid 32 to project to the phosphor screen side, the plane tip is used as a working area so that the electron beam BM becomes an almost parallel beam, thereby reducing the spot size of the electron beam BM.

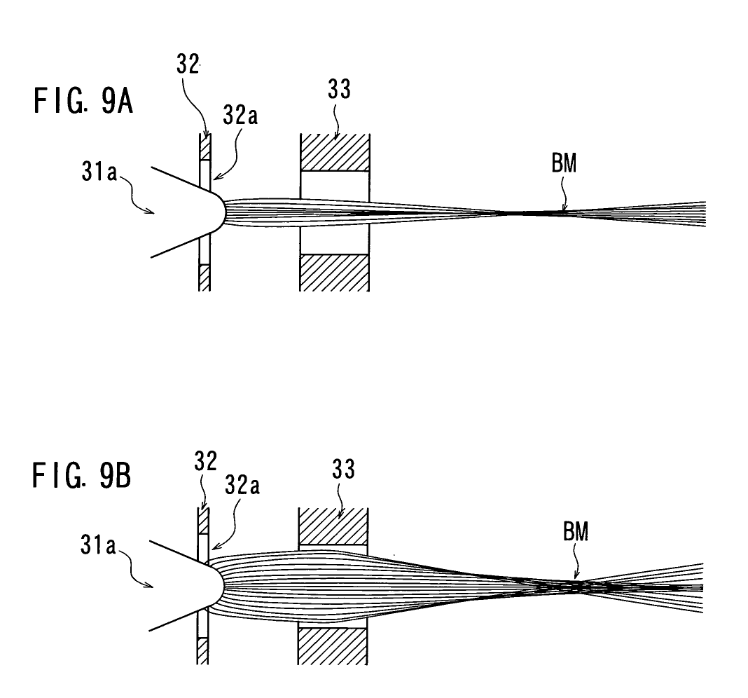

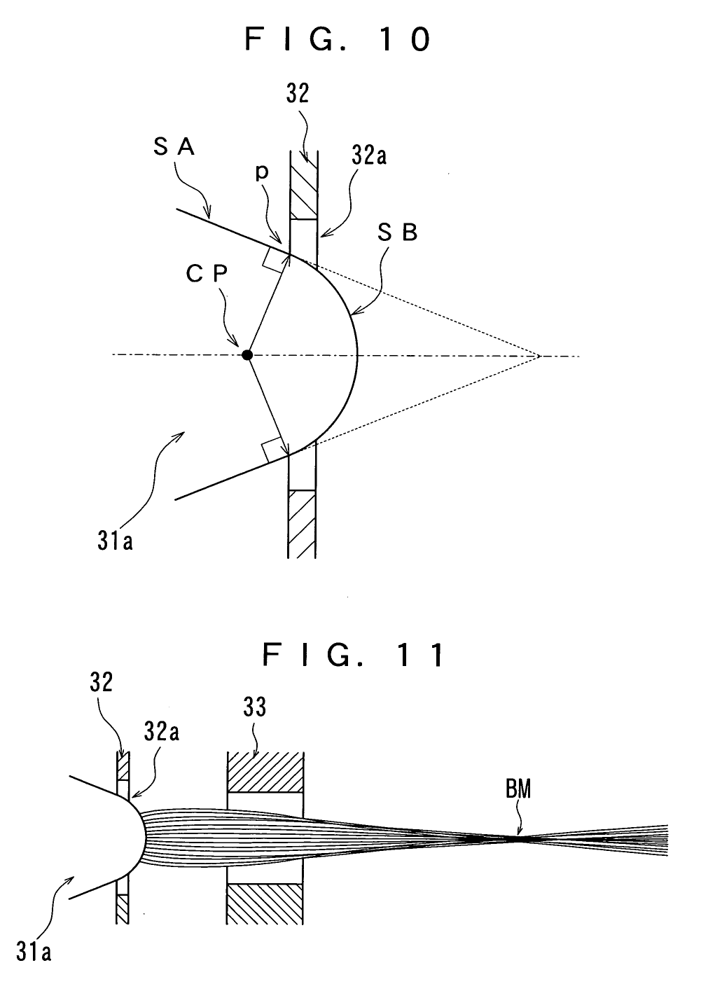

FIGS. 9A and 9B show the loci of electron beams in the case of using the cathode base shown in FIG. 7B. The tip of the cathode base having a cone shape has a curved face (the diagram shows the case where the tip has a spherical surface). In the case where the current amount of the beam current is small as described above, as shown in FIG. 9A, the curved surface of the tip serves as a working area, and the electron beam BM is output almost in parallel from the area, so that the spot size can be reduced. In the case where the current amount is large as described above, the working area becomes wide as shown in FIG. 9B, so that the electron beam BM is emitted not only from the curved surface at the tip but also side face. The electron beam BM emitted from the area apart from the center diverges from the center axis and passes through the second grid 33 and, after that, the locus of the electron beam BM converges on the center axis. Consequently, the locus difference occurs between the center and the peripheral portion and thus, the diameter of the electron beam flux increases. Moreover, in the spot of the electron beam BM displayed on the surface of the cathode ray tube, so called halation that the periphery is light and an image is blurred occurs.

Consequently, in the cathode base whose tip has a convex curved surface, the shape of the tip is set so that the area projected to the phosphor screen side from the first grid 32 and the area which is not projected but enters the first grid 32 form at least a convex-shaped curved surface.

FIG. 10 is a diagram showing the relation between the shape of the tip of the cathode base and the first grid. When the shape of the tip of the cathode base having a cone shape is, for example, a spherical shape, the tip SA of the spherical shape is formed so that the side face SB becomes a tangent to the tip SA of the spherical shape, thereby making the tip portion a continuous surface. By adjusting the cathode position so that the connection point p between the tip SA of the spherical shape and the side face SB is positioned to the cathode side more than the cathode face side of the first grid, the area projected to the phosphor screen side from the first grid 32 and the portion entered the first grid 32 can be formed as a curved surface.

FIG. 11 shows the locus of electron beam when the tip from the position of the first grid of the cathode base is formed as a convex-shaped curved surface. In this case, even when the current amount of the beam current is set to be large and the working area is widened, the electron beam BM is emitted from the curved-face portion. Consequently, as compared with the case of emitting the electron beam BM from the side face apart from the center, the electron beam BM travels along a locus close to the center axis and converges on the center axis. Therefore, the locus difference between the center and the periphery is reduced, and the diameter of the electron beam flux is decreased. Even when the current amount of the beam current is increased, occurrence of halation can be prevented, thereby obtaining the focus characteristic, which does not depend on current so much. As compared with the case of the sharpened tip of the cathode base, by forming the tip in a curved surface, excessive concentration of electric fields can be prevented, thereby improving the reliability thereof. Further, by forming the tip in a curved surface, the edge portion is eliminated at the tip of the cathode base, so that a notch or the like does not occur in the edge portion at the time of assembling the electron gun. Thus, productivity and quality can be also improved.

### INDUSTRIAL APPLICABILITY

The invention is useful to display a high-precision image while preventing occurrence of halation and to display an image of high luminance and is suitable to obtain a sharp electron beam spot of a small size.

1. (amended) An electron gun comprising a cathode having a tip thereof, said tip being formed in a plane shape, said tip being used as electron emission face and entering a hole in a first grid to project from said first grid.

2. (Amended) An electron gun comprising a cathode having a tip thereof, said tip being formed in a convex-shaped curved surface, said convex-shaped curved surface being used as electron emission face and entering a hole in a first grid to project from said first grid.

3. (Amended) A cathode ray tube comprising an electron gun including a cathode having a tip thereof, said tip being formed in a plane shape, said tip being used electron emission face and entering a hole in a first grid to project from said first grid.

4. (Amended) A cathode ray tube comprising an electron gun including a cathode having a tip thereof, said tip being formed in a convex-shaped curved surface, said convex-shaped curved surface being used as electron emission face and entering a hole in a first grid to project from said first grid.

5. (deleted)

6. (deleted)

7. (Amended) An image display device comprising:
a cathode ray tube including an electron gun having a cathode with a tip thereof, said tip being formed in a plane shape, said tip being used electron emission face and entering a hole in a first grid to project from said first grid; and
a drive circuit for driving said cathode ray tube to display an image.

8. (Amended) An image display device comprising:
a cathode ray tube including an electron gun having a cathode with a tip thereof, said tip being formed in a convex-shaped curved surface, said convex-shaped curved surface being used as electron emission face and entering a hole in a first grid to project from said first grid; and
a drive circuit for driving said cathode ray tube to display an image.

9. (Deleted)
